(19) United States
(12) Patent Application Publication
(10) Pub. No.: US 2010/0038110 A1
(43) Pub. Date: Feb. 18, 2010

(54) ELECTRICALLY CONDUCTIVE, MECHANICALLY FLEXIBLE CONNECTION BETWEEN ELECTRICAL AND ELECTRONIC COMPONENTS

(76) Inventors: Masoud Habibi, Schwieberdingen (DE); Klaus Zeh, Immerstadt (DE)

Correspondence Address: KENYON & KENYON LLP, ONE BROADWAY, NEW YORK, NY, 10004, US

(21) Appl. No.: 11/922,292

(22) PCT Filed: May 10, 2006
(86) PCT No.: PCT/EP2006/062188

§ 371 Date: Nov. 3, 2009

(30) Foreign Application Priority Data
Jun. 15, 2005 (DE) 10 2005 027 652.0

(51) Int. Cl. H01B 5/00

(52) U.S. Cl. 174/126.1

(57) ABSTRACT

An electrical device having an electrical connection, which is made of a connecting material, between a first electrical or electronic component which is acted upon by a first thermal coefficient of expansion, and a second electrical or electronic component, which is acted upon by a second thermal coefficient of expansion, there being a difference between the first and the second thermal coefficient of expansion, which is in the range of D>≈10*10 E-6/K.

### FIELD OF THE INVENTION

The present invention relates to an electrically conductive, mechanically flexible connection between a first electrical or electronic component, which is acted upon by a first thermal coefficient of expansion, and a second electrical or electronic component, which is acted upon by a second thermal coefficient of expansion.

### BACKGROUND INFORMATION

In the manufacturing of electrical and electronic circuits, the size of the component parts, among other things, is subject to a constant requirement for miniaturization. Because of this, the contact surfaces between the individual electrical and electronic components are also reduced, so that the connection between these contact surfaces of the individual components acquires a steadily increasing importance.

On the one hand, such connections are supposed to fulfill the requirements for good electrical conductivity, that is, have lowest possible electrical resistances, and on the other hand, these connections should be as robust as possible, so that the contact properties remain as unchanged as possible for as long as possible, even in the case of rough application conditions.

Rough operating conditions are created, among other things, by great temperature fluctuations, as occur, for example, in applications in the vehicle field, particularly in the engine compartment. In this context, temperature fluctuations between −40° C. and +150° C. constitute completely normal operating conditions.

In order to increase the integration density, such electronic components or circuits are often also installed directly in the housing of plug connections or the like, which are, however, made of materials whose thermal coefficient of expansion α is clearly different from that of the electrical and electronic components. But this brings about thermally conditioned stresses in passing through the operating temperature range at the connecting points between two such electrical and electronic components.

Let us mention, in this connection, an interference-suppression capacitor that is situated between two contact tabs of a plug connector using such a connection. Let the capacitor be, also for example, an SMD component (surface mounted device), having a substantially lower coefficient of linear expansion α than that of the material of the housing fixing these two contact tabs. However, because of this great difference Δα, massive mechanical loads come about, during the expansion of the housing, onto the contact points between the capacitor and the plug connector tabs that are designed, for instance, as a pressed screen.

Implementations of such connections up to the present are, for instance, soldered connections or even adhesive connections. Soldered connections are only able to be used up to a certain temperature range, which may be up to 125° C., since above that, the proper electrical connection between two electrical or electronic components can no longer be ensured. A soldered connection is used predominantly in a range in which ceramic chip components having a thermal coefficient with α=(6.5−10)*10E-6/K are fixed to a printed-circuit board material (such as FR4) having α=16*10E-6/K. This yields a difference of Δα<9.5*10E-6/K.

The adhesion of ceramic chip components having α=(6.5 to 10)*10E-6/K to Al₂O₃ (ceramic circuit substrate having a coefficient of expansion α=6.5*10E-6/K) is also known, there being a difference of Δα<3.5*10E-6/K in this case. Epoxy conductive adhesives may be used for this, having an elongation at break of A<2%.

A further structural concept is the adhering of ceramic SMD components onto pressed screens, for instance, in the form of coated copper traces, using hard epoxy adhesives. Subsequently to the adhesion, such a composite is extrusion-coated with a hard thermosetting plastic, in order that one may obtain reliable contacting having sufficient mechanical stability. The thermosetting plastic absorbs mechanical stresses in this case, so that the electrical properties of the connection remain intact, as well as possible over the entire temperature range.

An electrical switching unit is discussed in DE 38 37 206 A1, in which an adhesive filled with an electrically conductive material or a corresponding paste implements a capacitive coupling between two electric lines. It is true that this involves a flexible, electrically conductive connection, but its elasticity and its electrical conductivity are too low for it to be used in the area of application mentioned above.

Based on their mechanical properties, adhesives may basically be divided into three classes:
over the entire application temperature range, hard, brittle adhesives: e.g. epoxy resins having an elongation at break of 2% to 3% at most.
adhesives having a hard/soft transition in the application temperature range: e.g. flexibilized epoxy resins or epoxy resin-silicone copolymers having an elongation at break of 10% at the most.
over the entire application temperature range, flexible adhesives: e.g. silicones having a range of elongation at break which is able to extend from clearly below 10% to far above 150%.

Hard and brittle adhesives may demonstrate good conductivity, to be sure, but they are only suitable for fields of application in which low mechanical stresses occur in connections, because of small differences in two different coefficients of linear expansion α.

Adhesives in the second adhesives group, the one having the hard/soft transitions, are suitable for mechanically more greatly stressed applications, to be sure, than the ones from the first group, but they demonstrate a worsening in the elongation at break, by comparison, and consequently, they may cause a falling off or even a failure in the electrical properties at temperatures of >120° C.

The third group, that is, the adhesives that are flexible over the entire range of application, may in part even demonstrate extreme extensive capacity, to be sure, but this is greatly at the expense of the electrical conductivity, so that their range of application is thereby very greatly limited again.

### SUMMARY OF THE INVENTION

It is an object of the exemplary embodiments and/or exemplary methods of the present invention to improve such a connection between two electrical or electronic components.

Starting from an electrically conductive, mechanically flexible connection of the type indicated in the introduction, this objective is attained by the features described herein.

The further measures described herein make possible advantageous embodiments and further developments of the exemplary embodiments and/or exemplary methods of the present invention.

According to that, an electrically conductive, mechanically flexible connection between a first electrical or electronic component acted upon by a first thermal coefficient of expansion α1, and a second electrical or electronic component acted upon by a second thermal coefficient of expansion α2, is distinguished in that the difference D between the first thermal coefficient of expansion α1 and the second thermal coefficient of expansion α2 is in the range of D>approximately 10*10E-6/K

In one specific embodiment, the difference D is even in the range of D>approximately 20*10E-6/K. In the development of such a connection, the thermal coefficient of expansion αVₘ of the connecting material may be in the range of αVₘ approximately 420*10E-6/K. The effect on the connection is particularly favorable if the thermal coefficient of expansion α_{Vm} of connecting material Vₘ is in the range of α_{Vm}<approximately 250*10E-6/K.

Furthermore, it is regarded as being advantageous if the elongation at break B of a connecting material Vₘ of connection V is in the range of B>approximately 15%. Thus, one may do without additional extrusion of such a component part composite using a hard thermosetting plastic, as was required up to now, in order to protect the contacting thus implemented from mechanical stresses based on fluctuating operating temperatures.

In particular, it is regarded as being advantageous if elongation at break B of connecting material Vₘ of the connection is even in the range of B approximately >30%, the elongation at break being taken as being over the entire service life of the connection. This makes it possible to compensate for the relative motions between the components, without this having a negative effect on the electrical or mechanical properties of this connection V.

Thus one may contact in this way ceramic chip components having α=(6.5 to 10)*10E-6/K to pressed screens extruded thermoplastically, having a coefficient of linear expansion having approximately α=(60 to 100)*10E-6/K, it being ensured, with respect to the customary temperature application ranges, that both the ceramic component and connection V remain clearly below their maximally permissible mechanical stresses that are conditional upon their thermal linear expansion. Consequently, according to the exemplary embodiments and/or exemplary methods of the present invention, a difference in the thermal coefficient of expansion of Δα is manageable up to a range of 90*10E-6/K without a problem, in the contacting of two electronic components. Basically, this limit may even be definitely extended as a function of the individual components of connecting material V.

In order to ensure a sufficient electrical connection between the ceramic chip component and the pressed screen of coated copper extruded in thermoplastic, used, for example, as a plug connector tab, it may be the case if the specific electrical resistance R_{Sp} of connecting material Vₘ is in the range of R_{Sp}<approximately 1*10E-2 Ohm*cm at room temperature. In one specific embodiment, the specific electrical resistance R_{Sp} of connecting material Vₘ is even in the range of R_{Sp}<approximately 1*10E-3 Ohm*cm at room temperature.

Such values are made possible by the use of silver (AG) as connecting material Vₘ having a proportional weight G in the area of G>50 wt. % with respect to the connecting material. For this purpose, the base material of the connecting material may be an adhesive, based on a mechanically flexible, polymeric matrix, which is filled with silver particles, for instance, in the form of flakes, balls or the like. Because of this high filling ratio, it is ensured even in response to a large expansion of connecting material V, that the above-mentioned low specific electrical resistances are able to be maintained over the entire temperature application range.

It is true that adhesives are known which have a comparatively high proportion of silver, but this involves brittle adhesives having an elongation at break of ca. 2% to 3%, whose binders are epoxy. In the case of such adhesives, one may easily manage an enrichment using conductive filler materials, which may be in the form of silvered copper particles, but also in the form of silver, but they are lacking in elasticity.

By contrast, in the case where an adhesive is elastic over the entire application temperature range, such as silicone adhesives, which have an elongation at break that may range from well below 10% to well over 150%, this has not been possible up to now, because of the settling behavior of the heavy, electrically conductive filler materials. In particular in the case of silver, which has superb electrical conductivity, a steady positioning of the individual particles in the mechanically flexible, polymeric matrix has so far not been possible. However, with the aid of various series of experiments, an appropriately flexible, polymeric matrix has now been found, using which the above-mentioned values, and even still higher filling ratios, such as up to a range of over 90 wt. % of the connecting material are made possible. This brings with it extremely improved conductivity properties, so that, according to the exemplary embodiments and/or exemplary methods of the present invention, it is now possible to provide a reliable electrical connection between two electrical or electronic components using the above-mentioned parameters. This makes it possible, according to the exemplary embodiments and/or exemplary methods of the present invention, clearly to reduce the disadvantages known up to now in the related art, namely low flexibility of the connection at comparatively good electrical conductivity, or low electrical conductivity at correspondingly higher elasticity of the connection.

It is true that current application tests show that a silver proportion beginning at about 50%, but especially between about 75% and 85%, provides sufficiently good electrical and mechanical properties, for the application case tested, for instance an elongation at break of 30% over the entire temperature application range, at a specific electrical resistance, at room temperature, of R_{Sp}<1*10E-3 Ohm*cm to R_{Sp}<400*10E-3 Ohm*cm. However, it is entirely conceivable that a still higher filling ratio will be implemented using electrically conductive particles, especially silver.

This electrically conductive, mechanically flexible connection, according to the exemplary embodiments and/or exemplary methods of the present invention, may thus be used for connecting a first electrical or electronic component in the form of a miniaturized electrical component (SMD component) to a second electrical or electronic component, the second component being a conductor connection to a circuit substrate or to a third electrical or electronic component, a part of such a circuit substrate or the like.

Exemplary embodiments and/or exemplary methods of the present invention are represented in the drawings and subsequently further elucidated on the basis of the figures.

### BRIEF DESCRIPTION OF THE DRAWINGS

FIG. 1 shows a top view onto a connection between an electronic component (SMD) and two plug contact paths fixed in a plug connector housing.

FIG. 2 shows a section through the connection in FIG. 1.

FIG. 3 shows a top view onto a plug connector housing in which two first electronic components are fastened, according to the exemplary embodiments and/or exemplary methods of the present invention, to two second components.

### DETAILED DESCRIPTION

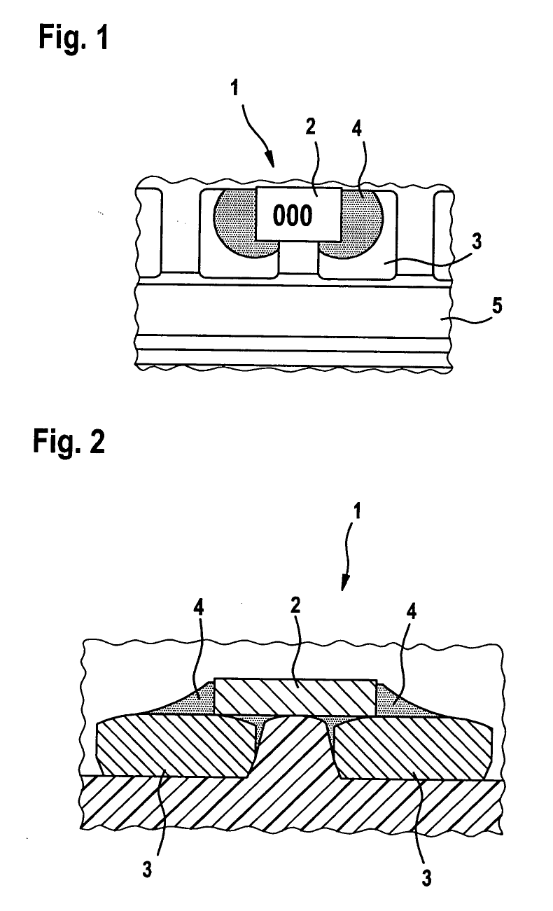

In detail, FIG. 1 now shows a top view onto an electrically conductive, mechanically flexible connection 1. This is developed between an SMD component (surface mounted device) having a comparatively low heat coefficient of expansion α1=6.5*10E-6/K and a second electronic component 3, in the form of thermoplastically extruded plug connection paths 3 having a heat coefficient of expansion α2 (60 to 100)*10E-6/K, that is comparatively high compared to the former.

This electrically conductive, mechanically flexible connection 1 is implemented using connecting material 4, according to the exemplary embodiments and/or exemplary methods of the present invention, by using which it is possible to ensure a difference of D between first thermal coefficient of expansion α1 and second thermal coefficient of expansion α2 in a range of D>approximately 10*10E-6/K over the entire application temperature range and over the entire service life of the usage. This applies both for the required electrical and mechanical properties of connection 1 according to the exemplary embodiments and/or exemplary methods of the present invention.

In one specific embodiment of a connection 1 according to the exemplary embodiments and/or exemplary methods of the present invention, difference D even lies in a range D>approximately 20*10E-6/K, so that compared to the first shown specific embodiment, even greater mechanical stresses, based on different thermal coefficients of expansion, are safely manageable. Thermal coefficient of expansion αVₘ of connecting material Vₘ may be in the range of αVₘ<approximately 450*10E-6/K in a first specific embodiment, in this instance, and in a second specific embodiment it is even in the range of αVₘ<approximately 250*10E-6/K.

The elongation at break B of connecting material 4, in the first specific embodiment, is in the range of B>approximately 15%, in this instance. This elongation at break B is a function of the binder used, which in this case may be a silicone and the filler material mixed with it, as well as of its filling ratio. According to that, elongation at break B may also vary. In order to produce an even more flexible connection, this may be even up to an elongation at break B of a second, specific embodiment (which may be used), in a range of B>approximately 30%.

With respect to the specific, electrical resistance R_{Sp} of connecting material 4, it may be the case, in a first specific embodiment, if the latter is in a range of R_{Sp}<approximately 1*10E-2, especially even in a range of R_{Sp}<approximately 1*10E-3. Because of this, the stray electrical effects, that were already clearly reduced in the first specific embodiment, such as capacitor effects, may be further reduced.

In this connection, the filler material of connecting material Vₘ is particularly important, which may be silver (AG), having a proportional weight G in the range G>50 wt. %, referred to the connecting material in a first specific embodiment. In a second specific embodiment, proportional weight G may even be in the range of G>approximately 75 wt. %.

In a large number of experiments carried out, we experimented with a filling ratio of the connecting material in which proportional weight G was, for instance, between 75% and 85%. All the experiments showed very good electrical properties, in combination with very good mechanical properties. Connecting material 4 according to the exemplary embodiments and/or exemplary methods of the present invention demonstrates particularly good properties in the range of G being approximately 81.5%±1%.

It is true that, on the one hand, the increase in this proportional weight G still increased the electrical properties, but on the other hand, one was able to determine a loss with respect to the mechanical flexibility, because of the reduction in elongation at break B. In response to the reduction of proportional weight G one was able to establish the opposite effects.

Silver AG as an electrically conductive component in connecting material 4 is introduced, in this instance, in particle form, which may be in the form of flakes, balls or the like.

The required high elasticity of a connecting material may be achieved particularly by using silicone polymer as adhesive component. This is a mechanically flexible polymeric matrix in which the electrically conductive filler may be situated. What is important, in this context, is that the electrically conductive filler material keeps its assigned place in the polymeric matrix, even in the non-cured state, over a long period of time. This ensures a uniform distribution of the electrically conductive components of connecting material 4 in the polymeric matrix, that is used as the skeletal structure, which, in turn, on its part, is the reason for the good electrical properties of connecting material 4, according to the exemplary embodiments and/or exemplary methods of the present invention.

This high filling ratio, having the above numerical values for proportional weight G, was able to be achieved by a new, suitable construction of adhesive component Kₖ in the form of silicone polymer, so that the disadvantage that was important up to now, namely the settling of the filler materials in adhesive component Kₖ was able to be clearly reduced. The second essential concept with respect to the good electrical properties is the use of the high proportion of silver, and the very good electrical properties connected therewith, in connecting material 4.

Besides adhesive component Kₖ, having a proportional weight in the range of G<approximately 20 wt. %, in particular, even G<approximately 10 wt. %, additional auxiliary substances are provided in a proportional weight in the range of G<approximately 2 wt. %, especially even a range of G<0.5 wt. %. Auxiliary substances H may be present, in this context, in the form of adhesion promoters, catalysts, inhibitors or the like.

As shown in FIGS. 1 and 2, a first component connected to this electrically conductive, mechanically flexible connection 1 may be a miniaturized, electronic component 2, for instance, in the form of an SMD component B1. A conductor connection L to a circuit substrate S or to a third electrical or electronic component B3 may be provided as second electrical or electronic component 3, or a part, for instance, of a printed circuit trace Lb of such a circuit substrate S, or the like. Second electrical or electronic component 3 or B2 is especially fixed in a plug connector housing 5, in this instance, whose material has a thermal coefficient of expansion α2, which is substantially higher than thermal coefficient of expansion α1 of first electronic component 2, see above.

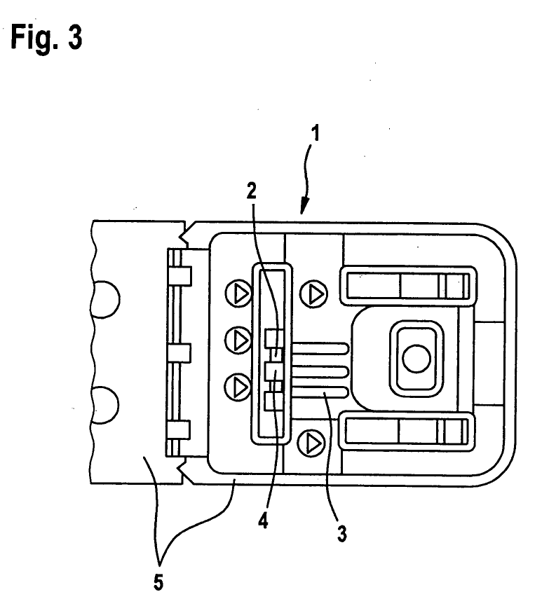

Because of such anchoring of second electrical or electronic component 3, such as in a plug connector housing 5 made of thermosetting plastic, as shown in FIG. 3, comparatively large stresses are created in connecting material 4 between first component 2 (B1) and second component 3 (B2), when passing through the operating temperature range. Based on the high elasticity at simultaneously good electrical properties of connection 1, according to the exemplary embodiments and/or exemplary methods of the present invention, this connection 1 is now, however, in a position to adjust for these mechanical stresses without connection 1 being damaged thereby, the very good electrical conductivity also being able to be maintained, at least over a wide range, at the same time.

Furthermore, in FIG. 3, besides the anti-interference capacitor, shown in exemplary fashion, one may also easily see connecting tabs 3 for the connection of an additional component, which may likewise be accommodated in plug connector housing 5.

1-13. (canceled)

14. An electrical device comprising:
an electrically conductive, mechanically flexible connection, which is of a connecting material, between a first electrical or electronic component, which is acted upon by a first thermal coefficient of expansion, and a second electrical or electronic component, which is acted upon by a second thermal coefficient of expansion;
wherein a difference between the first thermal coefficient of expansion and the second thermal coefficient of expansion is in the range of D>approximately 10*10E-6/K.

15. The electrical device of claim 14, wherein the difference is in the range of D>approximately 20*10E-6/K.

16. The electrical device of claim 14, wherein a thermal coefficient of expansion of the connecting material is in the range of α_{Vm}<approximately 450*10E-6/K.

17. The electrical device of claim 14, wherein a thermal coefficient of expansion of the connecting material is in the range of α_{Vm}<approximately 250*10E-6/K.

18. The electrical device of claim 14, wherein an elongation at a break of a connecting material of the connection is in the range of B>approximately 15%.

19. The electrical device of claim 14, wherein an elongation at a break of the connecting material of the connection is in the range of B>approximately 30%.

20. The electrical device of claim 14, wherein a specific electrical resistance of the connecting material is present at room temperature in the range of Rₛₚ<approximately 1*10E-2 Ohm.

21. The electrical device of claim 14, wherein a specific electrical resistance of the connecting material is present at room temperature in the range of Rₛₚ<approximately 1*10E-3 Ohm.

22. The electrical device of claim 14, wherein the connecting material includes silver having a proportional weight in the range of G>50 wt. %.

23. The electrical device of claim 14, wherein the connecting material includes silver having a proportional weight in the range of G>approximately 75 wt. %.

24. The electrical device of claim 14, wherein the connecting material includes an adhesive component in the form of a silicone polymer.

25. The electrical device of claim 14, wherein the first electrical or electronic component is a miniaturized electronic component.

26. The electrical device of claim 14, wherein the second electrical or electronic component is a conductor connection to a circuit substrate or to a third electrical or electronic component, which is a part of the circuit substrate.
